(19) United States
(12) Patent Application Publication
(10) Pub. No.: US 2002/0002448 A1
(43) Pub. Date: Jan. 3, 2002

(54) Means for incorporating software into avilability models

(75) Inventor: Mark A. Kampe, Los Angeles, CA (US)

Correspondence Address: HOGAN & HARTSON LLP, IP GROUP, COLUMBIA SQUARE, 555 THIRTEENTH STREET, N.W., WASHINGTON, DC, 20004, US

(73) Assignee: SUN MICROSYSTEMS, INC.

(21) Appl. No.: 09/850,183

(22) Filed: May 7, 2001

Related U.S. Application Data
(60) Provisional application No. 60/202,154, filed on May 5, 2000.

(51) Int. Cl. G06F 9/45

(52) U.S. Cl. 703/22

(57) ABSTRACT

A model and method that incorporates software into a network availability model is disclosed. An availability model models a platform having at least one software component having different classes of failures. The platform is within a network. The availability model includes a platform model for the platform parameters. The model also includes a software availability model within the platform model. The software availability model includes an aggregate failure rate for each of the classes of failures. The software availability model also includes an aggregate repair time for each of the classes of failures.

### CROSS-REFERENCE TO RELATED APPLICATIONS

This application claims the benefit of U.S. Provisional Patent Application No. 60/202,154 filed May 5, 2000, and entitled “MEANS FOR INCORPORATING SOFTWARE INTO AVAILABILITY MODELS,” which is hereby incorporated by reference.

### BACKGROUND OF THE INVENTION

1. Field of the Invention

The present invention relates to networks having nodes with hardware and software components. More particularly, the present invention relates to network modeling of a computer network with availability models for the hardware and software components of platforms within the computer network.

2. Discussion of the Related Art

Modeling of networks and devices within those networks is becoming increasingly important. Network modeling reduces costs of implementing the network because errors and problems can be identified early in the design process. In addition, different components within the network may be changed, added or deleted during testing and evaluation to reflect advances in technology or network requirements. Network components may be hardware devices, software applications, or a combination of both. Thus, hardware and software failures are desirable in modeling of a network. An effective model should include expected failure rates and time to repair/recover the different components.

A hardware repair may be relatively simple. For example, a service technician replaces the defective component. This repair action usually is successful. Software repairs, however, differ from hardware repairs. Software may be repaired by restarting some fraction of the system components, but such repair attempots often may fail. Software restarts may be escalated by restarting more components. These higher level repairs are often more effective. Multiple levels of escalation may exist.

A system may include a large number of distinct software components. Each component may have different failure rates and modes, and different levewls of restart may have different efficacies. The overall recovery time for a whole node is a non-trivial function of the recovery times for all of the individual software components.

Hardware failures may be modeled hierarchically such that the results of a complex lower level model can be wrapped up into a few failure rates in a higher level model. Thus, a complex system may be viewed as a rested set of simpler models. Software tends to have cross-level interactions, and it may be necessary to include all of the software components into the higher level models. Problems may arise from this practice because the complexity of a model is exponential in the number of components that it contains.

Software failures may be reduced down to a few states with standard failure and recovery rates, but the incoming rates are computed from the characteristics of a wide range of applications and system functions. In addition, different platforms for the applications may exist within the network. Thus, a need has arisen in the art for improved software failure modeling.

### SUMMARY OF THE INVENTION

Accordingly, a method and means for incorporating software into an availability model is disclosed. An embodiment of the present invention includes an availability model for a platform with at least one software component having different classes of failures. The platform is within a network. The availability model includes a platform model for the platform. The availability model also includes a software availability model within the platform model. The software availability model includes an aggregate failure rate for each of the classes of failures. The software availability model also includes an aggregate repair time for each of the classes of failures.

According to another embodiment, a method for incorporating a software component into a model of a network. The method includes determining failure rates for warm recoverable errors and non-warm recoverable errors of the software component. The method also includes determining the recovery rates for warm recoverable errors and non-warm recoverable errors of the software components. The method also includes generating warm recoverable error recovery rates. The method also includes generating non-warm recoverable error failure rates and the non-warm recoverable error recovery rates.

According to another embodiment, a network model of a network having at least one node is disclosed. The network model includes a node model for the node. The network model also includes node parameters for the node model. The node parameters include a reboot time, the network model also includes a warm recoverable software error state for the node model. The warm rcoverable software error state models warm recoverable software errors of software components on the node. The network model also includes a non-warm recoverable software error state for the node mode. The non-warm recoverable software state models non-warm recoverable software errors of the software components on the node.

According to another embodiment, a method for modeling a software error within a network model is disclosed. The method includes determining a recoverable state for the error. The method also includes, determining a recovery rate for the error. The method also includes incorporating the failure rate and the recovery rate into the recoverable state.

According to another embodiment, a computer program product comprising a computer useable medium having computer readable code embodied therein for incorporating a software component into a network. The computer program product adapted when run on a computer to effect the following steps. The steps include determining recovery rates for warm recoverable errors and non-warm recoverable errors of the software component. The steps include generating warm recoverable error state parameters from the warm recoverable error failure rates and the warm recoverable error recovery rates. The steps include generating non-warm recoverable error state parameters from the non-warm recoverable error failure rates and the non-warm recoverable error recovery rates.

According to another embodiment, a computer program product comprising a computer useable medium having computer readable code embodied therein for modeling a software error within a network model. The computer program product adapted when run on a computer to effect the following steps. The steps include determining a recoverable state for the error. The steps also include determining a failure rate for the error. The steps also include determining a recovery rate for the error. The executed steps also include incorporating the failure rate and the recovery rate into the recoverable state.

### BRIEF DESCRIPTION OF THE DRAWINGS

The accompanying drawings, which are included to provide a further understanding of the invention and are incorporated in and constitute a part of this specification, illustrate the disclosed embodiments. In the drawings:

FIG. 1 illustrates a network in accordance with an embodiment of the present invention;

FIG. 2 illustrates software modeling components in accordance with an embodiment of the present invention;

FIG. 3 illustrates a network platform within an overall network model in accordance with an embodiment of the present invention;

FIG. 4 illustrates a flowchart for determining software error states in accordance with an embodiment of the present invention; and

FIG. 5 illustrates a flowchart for constructing a software availability model in accordance with an embodiment of the present invention

### DETAILED DESCRIPTION OF THE PREFERRED EMBODIMENTS

Reference will now be made in detail to the preferred embodiments, examples of which are illustrated in the drawings.

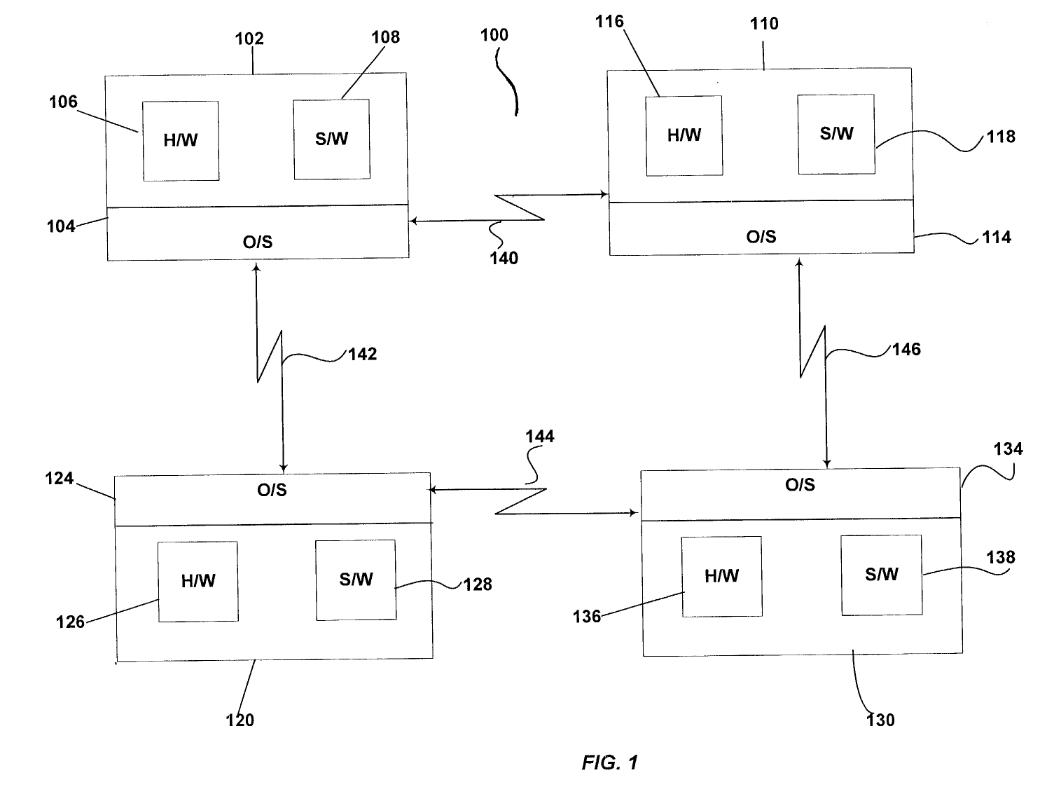

FIG. 1 depicts a network 100 having nodes according to an embodiment of the present invention. Network 100 includes nodes 102, 110, 120 and 130. Network 100 may include additional nodes, and all nodes are coupled to each other. Nodes 102, 110, 120 and 130 may be computers, or any platform that has hardware and software components. Preferably, nodes 102, 110, 120 and 130 can execute instructions from a computer-readable medium and store data. Network 100 exchanges information between the nodes, such as messages, communications, data packets, and the like.

Node 102 includes operating system 104, hardware component 106, and software application 108. Operating system 104 and software application 108 can be considered the software components of node 102. Repairs to software components may include restarting the application, rebooting node 102, and other activities that should not necessitate hardware fixes or repairs. Operating system 104 may be a program that, after being initially loaded into the node 102 by a boot program, manages all the other programs on node 102. The other programs may be called applications, such as software application 108. Software application 108 makes use of operating system 104 by making requests for services through a defined application program interface (not shown). In addition, users may interact directly with operating system 104 through a user interface such as a command language or a graphical user interface (not shown).

Hardware component 106 may be logic circuits, memory, a power supply, or any hardware component within node 102. Node 102 may include multiple hardware components 106, and is not limited by the embodiment depicted in FIG. 1. Hardware component 106 may have a failure rate, such as a mean time between failures, and a repair time. Node 102 also may have more than one software application 108, and may have different applications executing simultaneously. Operating system 104 supports the different software applications 108 and interfaces with the different hardware components 106. For the sake of simplicity, however, only one hardware component 106 and one software application 108 will be discussed with reference to FIG. 1.

Node 102 may exchange information with nodes 110, 120 and 130. Nodes 110, 120 and 130 may be similar to node 102 in that each node has an operating system, hardware components and software applications. For example, node 110 may include an operating system 114, a hardware component 116 and a software application 118. Node 120 may include an operating system 124, a hardware component 126 and a software application 128. Node 130 may include an operating system 134, a hardware component 136 and a software application 138. Nodes 102, 110, 120 and 130 may be coupled by connections 140, 142, 144 and 146. Connections 140, 142, 144 and 146 may be any medium capable of carrying information, such as wires, fiber optic material, wireless platforms, and the like. Further, connections 140, 142, 144 and 146 may link nodes in different physical locations.

Operating systems 104, 114, 124 and 134 may be the same operating systems, or, alternatively, may be different operating system able to exchange information. Messages, information, files and the like pass through the nodes without obstruction by the operating systems. Further, the hardware and software components on nodes 102, 110, 120 and 130 may differ. For example, software application 108 may be different than software application 138. Software application 108 may be an interactive electronic game, while software application 138 is a messaging program.

Hardware components 106, 116, 126 and 136 may have different failure rates and repair times. In addition, software components 108, 118, 128 and 138 may have different failures, failure resolution actions and recovery times. Thus, though nodes 102, 110, 120 and 130 may be within cluster network 100, the nodes may not be configured identically.

A model of network 100 would attempt to model the configuration of network 100, including the nodes and their components. The model would include failure and recovery modes for the components of network 100. Thus, the model reflects the availability of network 100. Hardware components 106, 116, 126 and 136 could be modeled using the different mean time between failures and mean time to repair for each component.

For example, a model for node 102 may include models for hardware component 106, as disclosed above, and operating system 104 and software application 108. Software application models are used for modeling operating system 104 and software application 108. As noted above, different failures may occur in operating systems and software applications that result in different recovery activities and times.

There are failure and recovery scenarios that are not contemplated by known models. First, after an application fails to restart or hand-over, the component will escalate to a cold start. Cold starts contribute additional time to the loss of service. Second, after node restarts fail to correct a problem, the network may go to cluster restart. Cluster restarts contribute greatly to the loss of service.

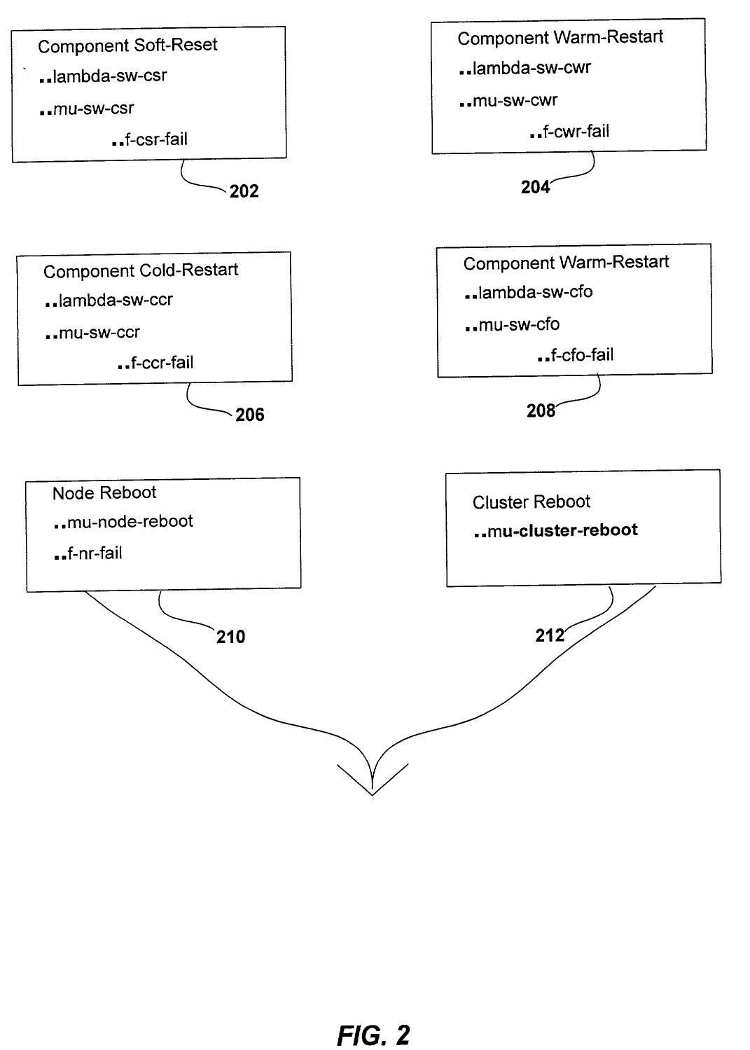

FIG. 2 depicts software component error states in accordance with an embodiment of the present invention. The different component error states depicted in FIG. 2 correlate to the different types of failures and recovery actions for a software application running on a node in network 100, such software application 108. The software modeling components also may be used to model operating systems on nodes, such operating system 104. Software applications, however, will be referred to in the discussion regarding FIG. 2.

Embodiments of the present invention characterize the behavior of individual software components in a clustered computer system and incorporate their combined effects into an understandable and maintainable model without losing the different behaviors of the individual software components. Availability models may characterize failure events by their implications, and not by their causes. The disclosed embodiments adopt this approach and distinguishes four classes of failures. The four classes may capture a large share of failure behavior. The classes may be intuitive and the associated parameters may be reasonably measurable or estimatable. The parameters of the these classes may be meaningfully summable.

Software failures may be divide into four classes. The first class may be application failures that can be corrected internally with no loss of service or state. The second class may be application failures that can be corrected by a restart, but probably will not lose the state. The third class may be applications failures that can be corrected by a restart, but will lose the state. The fourth class may be application failures that should be corrected by fail-over of the entire node to a back-up node within the cluster.

Each of the classes may be characterized by a failure rate, or inversely, a mean-time-between-failure (“MTBF”). The classes also may be characterized by a repair rate, or inversely, a mean-time-to-repair (“MTTR”). The classes further may be characterized by an efficacy, or the fraction of recoveries that will succeed. The implication being that a failure to recover will escalate to the next higher level of failure and recovery. Thus, every application may be characterized by these twelve parameters: MTBF, MTTR and efficacy for each of the four classes of failures.

The software modeling components may be derived by determining specific statistical information regarding each type of failure and the associated recovery action. Software component soft reset state 202 may reflect those failures having a recovery action that is automatically initiated by a component manager. Software component soft-resets include a warm restart of the application. Soft-resets, however, may include a warm restart only of a subset of the application. The failure rate for soft reset errors may be known as lambda-sw-csr.

The recovery rate for software component soft reset state 202 includes an error detect time and a recovery time to resolve the failure. For example, the recovery rate may be the time to detect the application failure and to soft reset the application.

This rate may be known as mu-sw-csr. Preferably, mu-sw-csr may be greater than or equal to about 1 Hz. Software component soft reset state 202 also includes a value for the fraction of repair failures. This value would model for recovery actions that are not effective in resolving the application failure, such as misdiagnosis of the failure, a corruption in the checkpoint stored for the application, miscellaneous failures to restart and the like. The fraction of recovery failures value may be known as f-csr-fail.

Software component warm restart state 204 may reflect those failures having a recovery action that is initiated by a component role assignment manager. Software components warm restarts include terminating and restarting the entire component.

For example, warm restart errors would be resolved by terminating the application and restarting it. This action recovers a previous checkpoint. The failure rate for warm restart errors may be known as lambda-sw-cwr.

The recovery rate for software component warm restart state 204 includes an error detect time and a recover time to resolve the failure. For example, the recovery rate may be the time to detect the application failure and to warm restart the application. This rate may be known as mu-sw-cwr. Preferably, mu-sw-cwr may be in the range of about 0.3 Hz to about 0.6 Hz. Software component warm restart state 204 also includes a value for the fraction of recovery failures. This value would model recovery actions that are not effective in resolving the application failure, such as misdiagnosis of the failure, a corruption in the checkpoint stored for the application, miscellaneous failures to restart and the like. The fraction of recovery failures value may be known as f-cwr-fail.

Software component cold restart state 206 may reflect those failures resolved by terminating and restarting the application. Cold restart would ignore any previously saved checkpoints and relaunch the application. The failure rate for cold restart errors may be known as lambda-sw-ccr.

The recovery rate for software component cold restart state 206 includes an error detect time and a recover time to resolve the failure. For example, the recovery rate may be the time to detect the application failure and to cold restart the application. This rate may be known as mu-sw-ccr. Preferably, mu-sw-ccr may be in the range of about 0.3 Hz to about 0.6 Hz. Software component cold restart state 206 also includes a value for the fraction of recovery failures. This value would serve to model recovery actions that are not effective in resolving the application failure, such as misdiagnosis of the failure, miscellaneous failures to restart and the like. The fraction of recovery failures value may be known as f-ccr-fail.

Software component fail-over state 208 may reflect those failures resolved by having all components on the affected node fail over to a hot standby. Recovery actions typically include a reboot of the affected node after being placed on hot standby. Rebooting nodes affect all components and not just the software application experiencing the failure. Node components would be rebooted, including hardware components. The failure rate for component fail-over may be known as lambda-sw-cfo.

The recovery rate for software component fail-over model 208 includes an error detect time and recover time to resolve the failure. For example, the recovery rate may be the time to detect the application failure and to reboot the node. This rate may be known as mu-sw-cfo. Preferably, mu-sw-cfo may be in the range of about 0.3 Hz to about 1 Hz. Software component fail-over state 208 also includes a value for the fraction of recovery failures. This value would serve to model recovery actions that are not effective in resolving the application failure, such as corruptions in the checkpoints, miscellaneous failures to restart and the like. The fraction of recover failures value may be known as f-cfo-fail.

Software component states 202, 204, 206 and 208 may be characterized as application-specific parameters. The statistics to model the components may be determined by running the applications. Further, the failures occur in the applications, and not necessarily on the node itself. Not all failures, however, are application-specific, but may occur in the operating system, or require recovery actions to occur on the node. These recovery actions may take longer to detect and resolve than application-specific errors.

An analogous approach may be failures. An operating system affects a large number of operations, and the operating systems on the various nodes cooperate. Slightly different failure classes may be assigned to an operating system failure. The first class may be problems requiring a single node reboot. The second class may be problems requiring a reboot of the entire cluster. The third class may be problems requiring service.

Software component node reboot state 210 may reflect those errors that are not resolved after all components fail-overs have taken place and result in a node reboot. Node reboots involve a complete reboot of the affected node, a complete restart of all components on the node, and a bringing on-board of the restarted components as secondaries. Further, the components may be brought up to date following a node reboot. Node reboots may occur after all the application specific recovery actions disclosed above have failed. In other words, node reboot is a software-driven recovery action that results in node intervention.

Software component node reboot state 210 may be characterized by a reboot rate known as mu-node-reboot. The reboot rate may reflect that time is takes to reboot the affected node, and bring all the node components back on-line. Preferably, mu-node-reboot may be from about 0.05 Hz to about 0.2 Hz. Software component node reboot state 210 also includes a value for the fraction of reboot failures. This value would serve to model reboots that are not effective in resolving the application failure, such as damage not confined to one node, miscellaneous failures to reboot and the like. The fraction of reboot failure value may be known as f-nr-fail.

Software component cluster reboot state 212 may reflect those errors that resolved by any of the above-disclosed models, and result in an entire network cluster reboot. If a node reboot is ineffective, a cluster reboot may be performed. A node reboot has not been effective in resolving the error. A cluster reboot involves a shutdown and reboot of all computers in the cluster. An error or failure impacting multiple nodes may be remedied by the cluster reboot. The rate of cluster reboots may be characterized by the time it takes to reboot the cluster network, and may be known as mu-cluster-reboot. Software component cluster reboot state 212 and software component node reboot state 210 may be characterized by platform-specific parameters. Platform-specific parameters indicate that the errors are not confined to a software application, and measures outside of restarting the application need to be taken.

The above-disclosed software component states utilize different values and rates to reflect failure rates and recovery rates. Each software component on a node, such as an application and the operating system, should be analyzed to determine the failure rates and recovery rates for each component. These values then may be used to determine overall values for the software components. This process should reduce the number of model components needed, but better reflect the failure characteristics of software within the model.

The various failure rates for each software component on the node should be determined. For example, the failure rate of errors requiring a local soft reset, or lambda-sw-csr, is determined for each software component. The lambda-sw-csr values for each component are used to determine the lambda-sw-csr for software component soft reset state 202. The failure rate of errors requiring a local application restart, or lambda-sw-cwr, is determined for each software component. The lambda-sw-cwr values for each component are used to determine the lambda-sw-cwr for software component warm restart state 204. The failure rate of errors requiring a component cold restart, or lambda-sw-ccr, is determined for each software component. The lambda-sw-ccr values for each component are used to determine the lambda-sw-ccr values for software component cold restart state 206. The failure rate of errors requiring a fail-over to another node, or lambda-sw-cfo, is determined for each software component. The lambda-sw-cfo values for each component are used to determine the lambda-sw-cfo for software component fail-over state 208.

Recovery times for the different possible software errors also are determined. First, a time to detect and identify a problem within the modeled node is determined, or time-sw-det. Next, a time for a soft reset, or time-sw-csr, is determined. A time for a warm restart, or time-sw-cwr, also is determined. A time for a cold restart, or time-sw-ccr, also is determined. A time for a component fail-over, or time-sw-cfo, also is determined. These time parameters are used to generate the associated detection and recovery rates for mu-sw-csr, mu-sw-cwr, mu-sw-ccr and mu-sw-cfo, as disclosed above.

Failure rates for the attempted recovery actions also are determined for each possible software error. For example, the fraction of soft resets, or f-csr-fail, that fail to fix the error is determined. The fraction of warm restarts, or f-cwr-fail, that fail to fix the errors is determined. The fraction of cold restarts, or f-ccr-fail, that fail to fix the errors is determined. The fraction of component fail-over, or f-cfo-fail, that fail to fix the errors is determined. Those recovery actions that fail to fix the error will be rolled over to another software component state. The fraction of failure parameters may be used to generate transition rates to other recovery and escalation states.

In addition to the above information for application parameters, estimates for various platform parameters may be determined. The platform parameters may be provided by the platform designers. The platform parameters include platform problems causing node reboot, or lambda-node-reboot, and the time to reboot the node, or time-node-reboot. Platform parameters also include the time to reboot all nodes in the network, or time-cluster-reboot, and the time to elect and start new master, or time-cluster-reform. The fraction of errors that are not fixed by rebooting a single node, or f-nr-fail, is determined. The platform parameters may be used to determine the parameters within software component node reboot state 210 and software component cluster reboot state 212.

According to an embodiment, the time parameters determined above may be combined with the time-sw-ccr parameters the application components in order to generate the node and cluster reboot rates. By incorporating application restart times into node restart times, a platform specific summation formula is determined that accounts for the plausible degrees of parallelism/serialization within the network.

Because of the fail-over of whole nodes may occur rather than individual software components, an aggregate node fail-over time is computed. The aggregate node fail-over time may be a platform specific summation of the component fail-over times for all the software components on a node. As noted above, these failure rates and recovery rates may be used to determine parameters for a single software failure model for a particular platform.

The aggregate failure rate of the whole system for each class of failure may be taken as the sum of the rates of all components for that class of failure. The aggregated repair times may be approximated by the average individual repair times and weighted by the relative failure rates. The modeled node reboot times should be determined as a sum of the platform/operating system reboot time and a platform specific function of the software component cold restart times. The purpose of the platform specific function is to recognize the possibility of parallel initialization of multiple applications. A worst case may be a sum of the cold restart times.

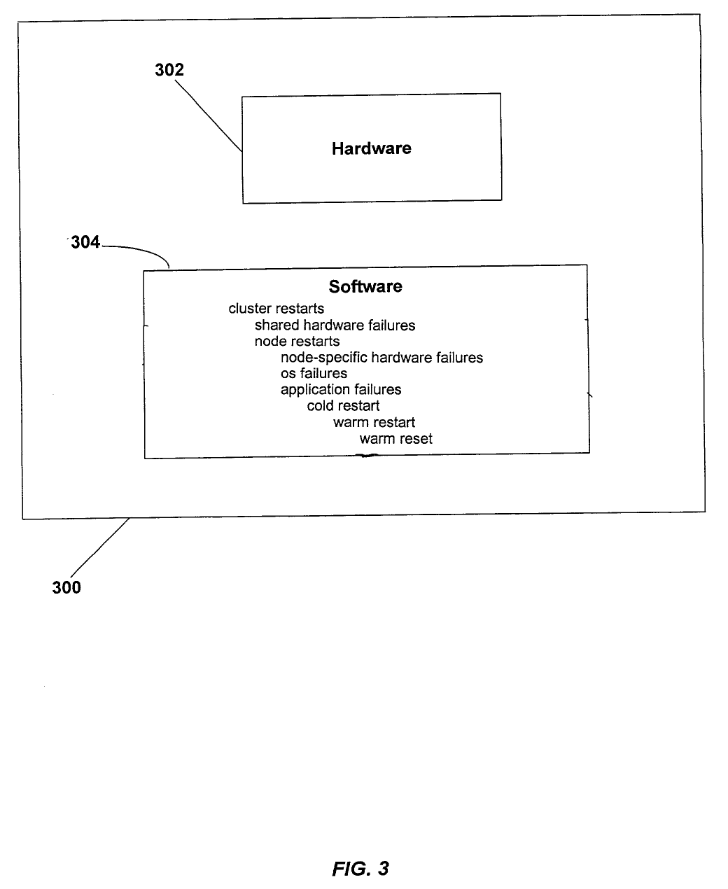

FIG. 3 depicts a network platform 300 within an overall network model in accordance with an embodiment of the present invention. Network platform 300 may be a node that is being modeled by a network model to determine performance characteristics, and has failure and recovery rate parameters for its components. For example, hardware component state 302 may indicate failure and recovery rates for hardware components in network platform 300. Software state 304 may indicate failure and recovery rates for software components, including the operating system, for network platform 300.

Software state 304 may be the system software availability model for the system software components. Software state 304 illustrates the containment relationships between the software application failures and the node failures. As noted above, failure to resolve a failure at one level may escalate recovery to the next highest level.

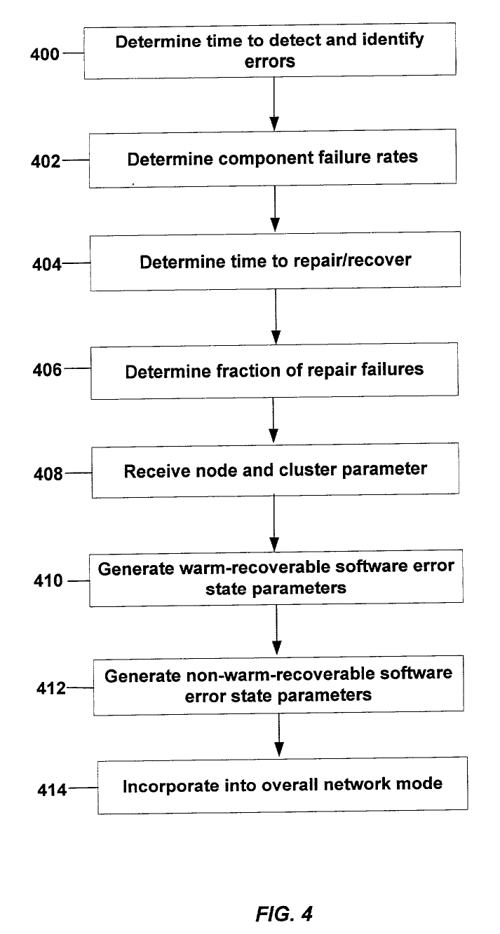

FIG. 4 depicts a flowchart for determining software error states for a network platform in accordance with an embodiment of the present invention. The network platform may be a node within the network. The platform has hardware and software components that are to be in the overall network model. Step 400 executes by determining the time to detect and identify a software error on the network platform. Specifically, the time to detect and identify a software error that leads to a recovery state to resolve the problem. Step 402 executes by determining the software component failure rates. Each software component provides failure rates for each type of failure. Referring back to FIG. 2, the failure rates include lambda-sw-csr, lambda-sw-cwr, lambda-sw-ccr, and lambda-sw-cfo. Step 404 executes by determining the time to repair or recover the software components on the network platform. Each software component provides recovery times for each type of failure. Referring back to FIG. 2, the recovery times may include mu-sw-csr, mu-sw-cwr, mu-sw-ccr, and mu-sw-cfo.

Step 406 executes by determining the fraction of repair/recovery failures that occur after-recovery actions have been done. Again, the fraction of failures are provided by each component for each type of failure. Referring back to FIG. 2, the fraction of failures may include f-csr-fail, f-cwr-fail, f-ccr-fail and f-cfo-fail.

Step 408 executes by receiving platform parameters for node and cluster recovery actions. The platform parameters may include time to reboot the node, time to reboot the cluster, and the fraction of node reboots that fail. Further parameters include the failure rate of errors resulting in node reboot.

Step 410 executes by determining the warm recoverable software error state parameters. By taking the failure rates, times to repair/recover, and fraction of failures determined above, the warm recoverable software error failure rate, time to recover and fraction of failure are calculated. According to an embodiment, the software components of the modeled platform provide the parameters for soft reset, warm restart and component fail-over error states to be used in this step.

Step 412 executes by determining the non-warm recoverable software error state parameters. By taking the failure rates and times to repair/recover determined above, the non-warm recoverable error failure rate, and time to repair/recover are calculated. According to an embodiment, the platform and software components of the modeled platform provides the parameters for component cold restart and node and cluster actions to be used in this step. Step 414 executes by incorporating the generated software error states for the platform into the overall network model.

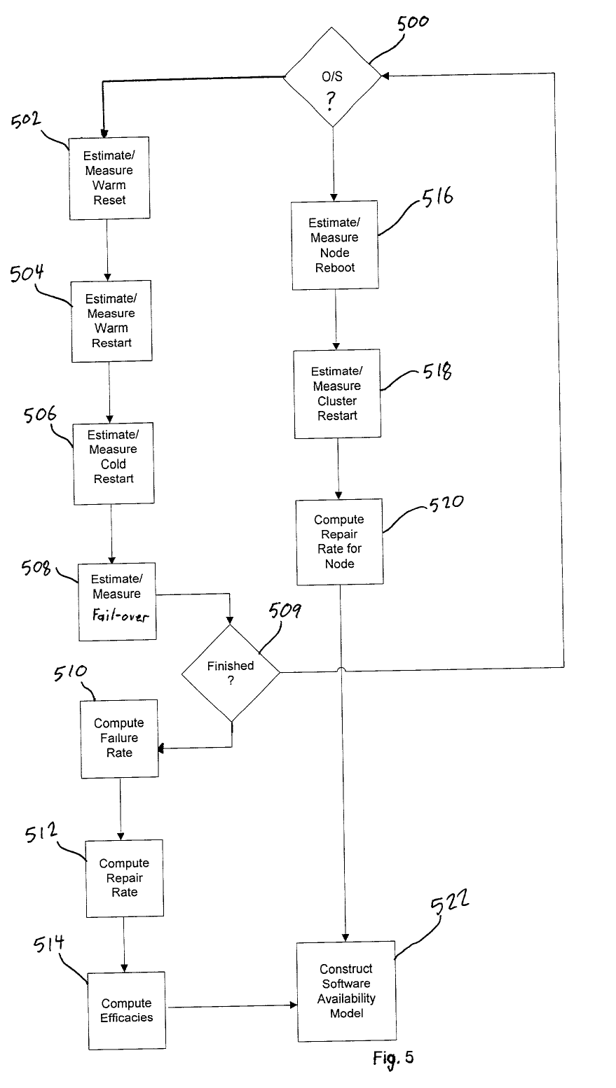

FIG. 5 depicts a flowchart for constructing a software availability model in accordance with an embodiment of the present invention. Step 500 executes by determining whether a component to be modeled is a software application or part of the operating system. If no, then step 502 executes by estimating/measuring the failure rate, repair time and efficacy value for the warm reset state. Step 504 executes by estimating/measuring the failure rate, repair time and efficacy value for the warm restart state. Step 506 executes by estimating/measuring the failure rate, repair time and efficacy value for the cold restart state. Step 508 executes by estimating/measuring the failure rate, repair time and efficacy value for the fail-over state.

Step 509 determines whether the parameters for all the modeled software component have been determined. If no, then the flowchart returns to step 500. If yes, then step 510 executes by computing the aggregated failure rate by summing the failure rate of corresponding components. Step 512 executes by computing the aggregated repair rate from failure rate-weighted average of corresponding component times. Step 514 executes by computing the aggregate efficacies for each repair rate from failure rate-weighted average of component efficacies.

If step 500 is yes, then step 516 executes by estimating/measuring the node reboot failure rate, repair time and efficacy value. Step 518 executes by estimating/measuring the cluster restart failure rate and repair time. Step 520 executes by computing a node reboot repair rate from a platform-specific sum of the operating system times and software component cold restart times.

Step 522 executes by using the aggregated failure rates, repair rates, and efficacies to construct the system software availability model for use in the network model. The system software availability model may act as if there was only one software component with failure and repair behavior described by the aggregate parameters.

According to the disclosed embodiments, a means and method are disclosed that incorporates software components into network availability models. The network could be computers linked by a communication medium, such as a cable, wire, fiber optics, Ethernet, wireless communications, and the like. For example, if a network has four nodes, then an overall network model would comprise models for each node. A node may be a platform having hardware and software components. If the platform is a computer, then hardware and software on the computer would be modeled to determine performance characteristics of the network. The hardware and software may be comprised of different components, each component having different failure rates, times to repair, repeat failures, repair/recovery actions, and the like.

The software components may be modeled in the overall network model on a per platform basis. In other words, the software components on each platform are included in the overall network model. Parameters are determined for each type of failure by calculating the failure rate, time to repair, and fraction of recovery failures for each software component. These parameters are summed together to provide parameters for each software error state that the software components may be subject to. The software error states include a component soft reset state, a component warm reset state, a component cold restart state, and a component fail-over state. Further, platform specific parameters are received, such as node reboot time, node failure rate, and cluster reboot time. These values are used to determine error states involving the platform or cluster in the recovery actions, such as a node reboot state, or a cluster reboot state.

Once the parameters of each is determined, the software availability model may be generated by calculating failure rates, time to recover and fraction of recovery failures for those actions that are warm recoverable and non-warm recoverable. Thus, software availability may be impacted by errors that result in recovery actions in the applications, or warm recoverable, or errors that result in recovery actions on the node or cluster, or non-warm recoverable. Errors that result in a loss of capacity and errors that result in a shut down of service are modeled separately. In the overall network model, a software application error in a program on the computer may only require the application be closed and restarted. Another error may require that the computer be rebooted. Separate treatment of these errors provides an increase in model accuracy and flexibility.

It will be appreciated by those skilled in the art that the present invention can be embodied in other specific forms without departing from the spirit or essential characteristics thereof. The presently disclosed embodiments are considered in all respects to be illustrative and not restricted. The scope of the invention is indicated by the appended claims rather than the foregoing description and all changes that come within the meaning and range and equivalence thereof are intended to be embraced therein.

What is claimed is:

1. An availability model for a platform with at least one software component having different classes of failures, said platform within a network, comprising:
a platform model for said platform; and
a software availability model within said platform model, said software availability model including an aggregate failure rate for each of said classes of failures and an aggregated repair time for each of said classes of failures.

2. The availability model of claim 1, wherein said platform includes platform parameters.

3. The availability model of claim 1, further including a hardware component model within said platform model.

4. The availability model of claim 1, wherein said aggregate repair time includes a time to detect and identify an error

5. The availability model of claim 1, wherein said platform is a node in said network.

6. A network model of a network having at least one node, comprising:
a node model for said at least one node;
node parameters for said node model, said node parameters including a reboot time; and
a software availability model having an aggregated failure rate and an aggregated repair time for each software component on said at least one node wherein each software component has different error levels and said software availability model represents each of said different error levels.

7. The network model of claim 6, further comprising a hardware component model for said at least one node.

8. A method for incorporating a software component into a model of a network, comprising:
determining failure rates for warm recoverable errors and non-warm recoverable errors of said software component;
determining recovery rates for warm recoverable errors and non-warm recoverable errors of said software component;
generating warm recoverable error state parameters from said warm recoverable error failure rates and said warm recoverable error recovery rates; and
generating non-warm recoverable error state parameters from said non-warm recoverable error failure rates and said non-warm recoverable error recovery rates

9. The method of claim 8, further comprising determining a fraction of recovery failures for said warm recoverable software errors.

10. The method of claim 9, wherein said first generating step includes said fraction of recovery failures for said warm recoverable software errors.

11. The method of claim 8, further comprising determining a fraction of recovery failures for said non-warm recoverable software errors.

12. The method of claim 11, wherein said second generating step includes said fraction of recovery failures for said non-warm recoverable software errors.

13. The method of claim 8, further comprising receiving node recovery parameters.

14. The method of claim 13, wherein said node recovery parameters include node reboot parameters.

15. The method of claim 8, further comprising receiving network recovery parameters, including network reboot parameters.

16. A method for modeling a software error within a network model, comprising:
determining a recoverable state for said error;
determining a failure rate for said error;
determining a recovery rate for said error; and
incorporating said failure rate and said recovery rate into said recoverable state.

17. The method of claim 16, further comprising determining a fraction of recovery failures for said error, and incorporating said fraction of repair failures into said recoverable state.

18. A computer program product comprising a computer useable medium having computer readable code embodied therein for incorporating a software component into a model of a network, the computer program product adapted when run on a computer to effect steps including:
determining failure rates for warm recoverable errors and non-warm recoverable errors of said software components;
determining recovery rates for warm recoverable errors and non-warm recoverable errors of said software component;
generating warm recoverable error state parameters from said warm recoverable error failure rates and said warm recoverable error recovery rates; and
generating non-warm recoverable error state parameters from said non-warm recoverable error failure rates and said non-warm recoverable error recovery rates.

19. A computer program product comprising a computer useable medium having computer readable code embodied therein for modeling a software error within a network model, the computer program product adapted when run on a computer to effect steps including:
determining a recoverable state for said error;
determining a failure rate for said error;
determining a recovery rate for said error; and
incorporating said failure rate and said recovery rate into said recoverable state.
